(19) United States
(12) Patent Application Publication
(10) Pub. No.: US 2021/0316993 A1
(43) Pub. Date: Oct. 14, 2021

(54) METHOD FOR PREPARING FUNCTIONALIZED GRAPHENE

(71) Applicant: Huaqiao University, Quanzhou (CN)

(72) Inventors: Guohua CHEN, Quanzhou (CN); Jianfeng XU, Quanzhou (CN); Songlin CHEN, Quanzhou (CN)

(21) Appl. No.: 17/358,468

(22) Filed: Jun. 25, 2021

Related U.S. Application Data
(63) Continuation of application No. PCT/CN2020/098490, filed on Jun. 28, 2020.

(30) Foreign Application Priority Data
Jun. 27, 2019 (CN) 201910566013.8

(51) Int. Cl. C01B 32/194; C01B 32/225; C01B 32/19

(52) U.S. Cl. CPC C01B 32/194; C01B 32/19; C01B 32/225

(57) ABSTRACT

A method for preparing functionalized graphene. (1) Flake graphite and a dienophile or a diene are mixed in an organic solvent uniformly to obtain a mixed solution. (2) In an inert atmosphere or under vacuum, the mixed solution obtained in step (1) is subjected to graphite exfoliation and Diels-Alder (DA) reaction in a mechanical exfoliation device to obtain a crude product. (3) The crude product obtained in step (2) is subjected to heat preservation to obtain the functionalized graphene.

### CROSS-REFERENCE TO RELATED APPLICATIONS

This application is a continuation of International Patent Application No. PCT/CN2020/098490, filed on Jun. 28, 2020, which claims the benefit of priority from Chinese Patent Application No. 201910566013.8, filed on Jun. 27, 2019. The content of the aforementioned applications, including any intervening amendments thereto, is incorporated herein by reference in its entirety.

### TECHNICAL FIELD

This application relates to graphene preparation, and more particularly to a method for preparing functionalized graphene.

### BACKGROUND

The Diels-Alder (D-A) reaction is a cycloaddition reaction, in which the reactants include a diene to provide a conjugated diene and a dienophile to provide an unsaturated bond. The D-A reaction has become one of the most important ways for forming carbon-carbon bonds in the organic synthesis due to its desirable thermal reversibility, selectivity, yield, reliability and environmental tolerance.

The D-A reaction is often used to modify carbon materials with a special aromatic structure. In 2011, Haddon et al. reported that since graphite and graphene has a band gap of zero, they can work as a diene or dienophile to participate in the D-A reaction. The related D-A reaction of graphene was also reported. Though the D-A reaction has been used in the preparation of graphite and graphene, the preparation process usually has low reaction degree, undesirable graphite exfoliation efficiency and high preparation cost.

### SUMMARY

In a first aspect, the present disclosure provides a method for preparing functionalized graphene, which comprises:

(1) mixing flake graphite with a dienophile or a diene in an organic solvent uniformly to obtain a mixed solution;

(2) subjecting the mixed solution obtained in step (1) to graphite exfoliation and Diels-Alder (DA) reaction in a mechanical exfoliation device in an inert atmosphere or under vacuum to obtain a crude product; and

(3) subjecting the crude product obtained in step (2) to heat preservation to obtain the functionalized graphene.

In some embodiments, in step (1), the dienophile is selected from the group consisting of tetracyanoethylene, perchloroethylene, butanedioic acid and a combination thereof.

In some embodiments, in step (1), the diene is selected from the group consisting of maleic anhydride, maleimide, furfurylamine, furancarbinol and a combination thereof. In some embodiments, in step (1), the diene is selected from the group consisting of maleic anhydride, maleimide and a combination thereof.

In some embodiments, in step (1), a weight of the dienophile or the diene is no more than 50 times a weight of the flake graphite. In some embodiments, in step (1), a weight ratio of the flake graphite to the dienophile or the diene is 1:(0.5-2). In some embodiments, the weight ratio of the flake graphite to the dienophile or the diene is 1:2.

In some embodiments, in step (1), the organic solvent is selected from the group consisting of N,N-dimethylformamide, N-methylpyrrolidone, tetrahydrofuran, dichloromethane, chloroform and a combination thereof.

In some embodiments, in step (1), a weight of the organic solvent is no more than 1000 times a weight of the flake graphite. In some embodiments, in step (1), a weight ratio of the organic solvent to the flake graphite is (10-100):1.

In some embodiments, in step (1), the mixing is performed by ultrasonic mixing or stirring mixing. In some embodiments, the ultrasonic mixing is performed at 100-200 W for 3-10 min. In an embodiment, the ultrasonic mixing is performed at 100 W for 5 min.

In some embodiments, in step (2), the inert atmosphere is N₂ atmosphere or Ar atmosphere.

In some embodiments, in step (2), the mechanical exfoliation device is a planetary ball mill, a basket grinder, a shear mixer, an ultrasonic generator or a combination thereof.

In some embodiments, in step (2), a rotational speed of the mechanical exfoliation device is 300-1000 r/min. In some embodiments, in step (2), the rotational speed of the mechanical exfoliation device is 450 r/min.

In some embodiments, in step (2), the graphite exfoliation is performed for no more than 48 h. In some embodiments, in step (2), the graphite exfoliation is performed for 6-48 h. In some embodiments, in step (2), the graphite exfoliation is performed for 24 h.

In some embodiments, in step (3), the heat preservation is performed at 60-300° C. for 1-15 days. In some embodiments, in step (3), the heat preservation is performed at 70-200° C. for 2-10 days. In some embodiments, in step (3), the heat preservation is performed at 80-100° C. for 3-7 days. In an embodiment, in step (3), the heat preservation is performed at 100° C. for 3 days.

In some embodiments, the method further comprises:

washing the functionalized graphene obtained in step (3) with dilute hydrochloric acid and water sequentially.

In some embodiments, a mass concentration of the dilute hydrochloric acid is 1-5%. In some embodiments, the mass concentration of the dilute hydrochloric acid is 2%.

In a second aspect, the present disclosure provides a functionalized graphene prepared by the above-mentioned method.

Compared with the existing mechanical methods for preparing a functionalized graphene dispersion, this disclosure has the following beneficial effects.

1. In the method provided herein, the functionalized graphene can be directly prepared from flake graphite by combining liquid phase mechanical exfoliation with the Diels-Alder reaction.

2. In the method provided herein, the mechanical exfoliation device also works as a mixing and reaction vessel. Moreover, the exfoliation process is accompanied by the occurrence of the D-A reaction of natural flake graphite, such that the flake graphite can undergo efficient mixing, effective intercalation and D-A reaction with the diene or dienophile when subjected to shear and impact under the mechanical force. Then the reaction product is subjected to a simple heat preservation process to produce the desired functionalized graphite. The method of the disclosure enables the one-step preparation, and avoids the preparation of an intermediate graphene or graphene oxide. Since the stable conjugated structure on the graphite base surface is partially broken by the D-A reaction, the prepared functionalized graphene has excellent dispersibility in most solvents. The method of the disclosure not only effectively improves the dispersion of graphite and graphene in various solvents and matrices, but also has simple, environmentally friendly, efficient, and economical operations, and thus it is considered to be suitable for the large-scale production of functionalized graphene.

3. The heat preservation after ball milling further improves the efficiency of D-A reaction and increases the grafting rate of the diene or dienophile with the graphene. Without the heat preservation, the efficiency of the D-A reaction will decrease and the functionalization degree of graphene will become lower.

### BRIEF DESCRIPTION OF THE DRAWINGS

FIG. 1 is a flowchart of a method for preparing functionalized graphene provided in Example 1 of the present disclosure; and

FIGS. 2A-2B show a comparison of the functionalized graphene prepared in Example 1 (2A) and graphene (2B) prepared by a commercial mechanical exfoliation method in terms of dispersibility in aqueous phase and organic phase.

### DETAILED DESCRIPTION OF EMBODIMENTS

The technical solutions of the present disclosure will be further described below with reference to the embodiments.

### Example 1

Provided herein was a method for preparing functionalized graphene, which included the following steps.

a) 0.3 g of natural flake graphite and 0.6 g of maleic anhydride were added into 30 mL of N-methylpyrrolidone, and ultrasonicated at room temperature and an ultrasonic power of 100 W for 5 min, until the maleic anhydride was completely dissolved, so as to obtain a mixed solution.

b) The mixed solution obtained in step (a) to was transferred to a ball-mill tank. The ball-mill tank was fed with N₂ to form a N₂ inert environment, and then placed in a planetary ball mill. The ball-milling graphite exfoliation was performed at 450 r/min for 24 h, and then the ball-mill tank was taken out from the planetary ball mill.

c) The ball-mill tank was then placed in an oven at 100° C. for 3 days.

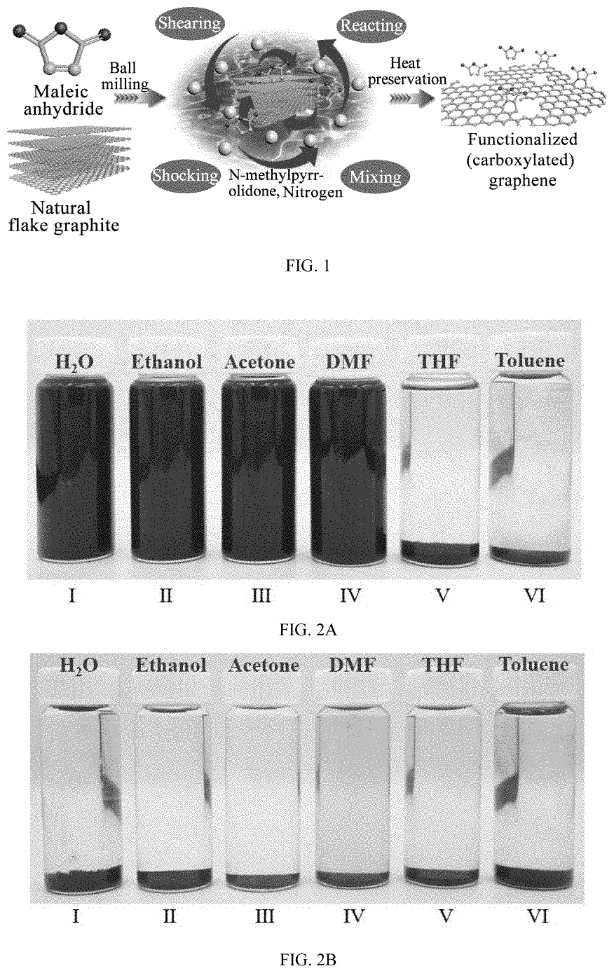

d) A graphene slurry in the ball-mill tank was collected, washed with 2% dilute hydrochloric acid several times, and then washed with deionized water until a supernatant was neutral. Then the graphene slurry was centrifuged to obtain a bottom product, which was the graphene chemically grafted with maleic anhydride on the edge and base surface. The bottom product was subjected to hydrolysis, so as to obtain the functionalized graphene, that was, the carboxylated graphene. A flow chart of the preparation method provided herein was shown in FIG. 1.

The carboxylated graphene prepared herein was tested for the dispersibility and then compared with a graphene product (G2, Xiamen Knano Graphene Technology Co., Ltd., China) prepared by a commercial mechanical exfoliation method in terms of dispersibility in an aqueous phase (group I: water) and some organic solvents (groups II-VI: ethanol, acetone, dimethylformamide, tetrahydrofuran and toluene, respectively), and the results were shown in FIGS. 2A-2B. It can be observed that the carboxylated graphene prepared herein exhibited good dispersibility in the water phase and some organic phases (ethanol, acetone and dimethylformamide), and by contrast, the dispersibility of the graphene prepared by the commercial mechanical exfoliation was far poorer than that of the carboxylated graphene.

### Example 2

Provided herein was a method for preparing functionalized graphene, which included the following steps.

a) 0.3 g of natural flake graphite and 0.6 g of maleimide were added into 30 mL of N-methylpyrrolidone, and ultrasonicated at room temperature and an ultrasonic power of 100 W for 5 min, until the maleimide was completely dissolved, so as to obtain a mixed solution.

b) The mixed solution obtained in step (a) to was transferred to a ball-mill tank. The ball-mill tank was fed with N₂, and then placed in a planetary ball mill. The ball-milling graphite exfoliation was performed at 450 r/min for 24 h, and then the ball-mill tank was taken out from the planetary ball mill.

c) The ball-mill tank was then placed in an oven at 100° C. for 3 days.

d) A graphene slurry in the ball-mill tank was collected, and washed with 2% dilute hydrochloric acid several times, and then washed with deionized water until a supernatant was neutral. Then the graphene slurry was centrifuged to obtain a bottom product, that was, the aminated graphene.

### Example 3

The preparation method adopted in this example was basically the same as that adopted in Example 1 except that the maleic anhydride in step (1) was replaced with furfuryl amine.

### Example 4

The preparation method adopted in this example was basically the same as that adopted in Example 1 except that the maleic anhydride in step (1) was replaced with furancarbinol.

### Example 5

Provided herein was a method for preparing functionalized graphene, which included the following steps.

a) 0.3 g of natural flake graphite and 0.6 g of maleic anhydride were added into 30 mL of N,N-dimethylformamide, and ultrasonicated at room temperature and an ultrasonic power of 100 W for 5 min, until the maleic anhydride was completely dissolved, so as to obtain a mixed solution.

b) The mixed solution obtained in step (a) to was transferred to a ball-mill tank. The ball-mill tank was fed with N₂, and then placed in a planetary ball mill. The ball-milling graphite exfoliation was performed at 450 r/min for 24 h, and then the ball-mill tank was taken out from the planetary ball mill.

c) The ball-mill tank was then placed in an oven at 100° C. for 3 days.

d) A graphene slurry in the ball-mill tank was collected, and washed with 2% dilute hydrochloric acid several times, and then washed with deionized water until a supernatant was neutral. Then the graphene slurry was centrifuged to obtain a bottom product, that was, the carboxylated graphene.

### Example 6

Provided herein was a method for preparing functionalized graphene, which included the following steps.

a) 0.3 g of natural flake graphite and 0.6 g of maleic anhydride were added into 30 mL of N-methylpyrrolidone, and ultrasonicated at room temperature and an ultrasonic power of 100 W for 5 min, until the maleic anhydride was completely dissolved, so as to obtain a mixed solution.

b) The mixed solution obtained in step (a) to was transferred in a ball-mill tank. The ball-mill tank was fed with N₂, and then placed in a planetary ball mill. The ball-milling graphite exfoliation was performed at 450 r/min for 24 h, and then the ball-mill tank was taken out from the planetary ball mill.

c) The ball-mill tank was then placed in an oven at 80° C. for 7 days.

d) A graphene slurry in the ball-mill tank was collected, and washed with 2% dilute hydrochloric acid several times, and then washed with deionized water until a supernatant was neutral. Then the graphene slurry was centrifuged to obtain a bottom product, that was, the carboxylated graphene.

The above embodiments and accompany drawings are not intended to limit this disclosure, and it should be understood that any variations and modifications made by those skilled in the art without departing from the spirit of this disclosure should fall within the scope of the present disclosure defined by the appended claims.

What is claimed is:

1. A method for preparing functionalized graphene, comprising:
(1) mixing flake graphite with a dienophile or a diene in an organic solvent uniformly to obtain a mixed solution;
(2) subjecting the mixed solution obtained in step (1) to graphite exfoliation and Diels-Alder (DA) reaction in a mechanical exfoliation device in an inert atmosphere or under vacuum to obtain a crude product; and
(3) subjecting the crude product obtained in step (2) to heat preservation to obtain the functionalized graphene.

2. The method of claim 1, wherein in step (1), the dienophile is selected from the group consisting of tetracyanoethylene, perchloroethylene, butanedioic acid and a combination thereof.

3. The method of claim 1, wherein in step (1), the diene is selected from the group consisting of maleic anhydride, maleimide, furfurylamine, furancarbinol and a combination thereof.

4. The method of claim 1, wherein in step (1), a weight of the dienophile or the diene is no more than 50 times a weight of the flake graphite.

5. The method of claim 1, wherein in step (1), a weight ratio of the flake graphite to the dienophile or the diene is 1:(0.5-2).

6. The method of claim 1, wherein in step (1), the organic solvent is selected from the group consisting of N,N-dimethylformamide, N-methylpyrrolidone, tetrahydrofuran, dichloromethane, chloroform and a combination thereof.

7. The method of claim 1, wherein in step (1), a weight of the organic solvent is no more than 1000 times a weight of the flake graphite.

8. The method of claim 1, wherein in step (1), a weight ratio of the organic solvent to the flake graphite is (10-100):1.

9. The method of claim 1, wherein in step (1), the mixing is performed by ultrasonic mixing or stirring mixing.

10. The method of claim 9, wherein the ultrasonic mixing is performed at 100-200 W for 3-10 min.

11. The method of claim 1, wherein in step (2), the inert atmosphere is N₂ atmosphere or Ar atmosphere.

12. The method of claim 1, wherein in step (2), the mechanical exfoliation device is a planetary ball mill, a basket grinder, a shear mixer, an ultrasonic generator or a combination thereof.

13. The method of claim 1, wherein in step (2), a rotational speed of the mechanical exfoliation device is 300-1000 r/min.

14. The method of claim 1, wherein in step (2), the graphite exfoliation is performed for no more than 48 h.

15. The method of claim 1, wherein in step (2), the graphite exfoliation is performed for 6-48 h.

16. The method of claim 1, wherein in step (3), the heat preservation is performed at 60-300° C. for 1-15 days.

17. The method of claim 1, wherein in step (3), the heat preservation is performed at 70-200° C. for 1-15 days.

18. The method of claim 1, further comprising:
washing the functionalized graphene obtained in step (3) with dilute hydrochloric acid and water sequentially.

19. The method of claim 18, wherein a mass concentration of the dilute hydrochloric acid is 1-5%.

20. A functionalized graphene, wherein the functionalized graphene is prepared by the method of claim 1.
